(19) United States
(12) Patent Application Publication
(10) Pub. No.: US 2011/0203485 A1
(43) Pub. Date: Aug. 25, 2011

(54) BLEACHING METHOD

(75) Inventors: Risto Rahkola, Keikya (FI); Birgitta Peltopakka, Roismala (FI); Hannu Hämäläinen, Vaasa (FI); Jonas Konn, Inkoo (FI); Sari Vahlroos-Pirneskoski, Oulu (FI)

(73) Assignee: KEMIRA OYJ, Helsinki (FI)

(21) Appl. No.: 13/126,577

(22) PCT Filed: Oct. 30, 2009
(86) PCT No.: PCT/FI2009/050872

§ 371 Date: May 12, 2011

(30) Foreign Application Priority Data
Oct. 31, 2008 (FI) 20086031

(51) Int. Cl. C09C 1/00; D21C 9/16; D21H 17/66; C09C 1/36; C09C 1/28; C09C 1/02

(52) U.S. Cl. 106/417; 162/78; 162/181.3; 106/400; 106/488; 106/436; 106/483; 106/469; 106/463; 106/461

(57) ABSTRACT

Methods for treating lignocellulosic material or pigment with a reductive bleaching solution generally include washing the lignocellulosic material or pigment with a reducing agent of magnesium dithionite. The method includes at least one reductive stage and at least one peroxide stage. Also disclosed are methods for preparing dithionite solution wherein magnesium bisulfite is reduced with borohydride solution to obtain dithionite. Bleached lignocellulosic material or pigment obtained with the treatment methods are also disclosed.

### FIELD OF THE INVENTION

The present invention relates to a method for treating lignocellulosic material or pigment with a reductive bleaching solution. More particularly, the present invention relates to a method for bleaching lignocellulosic material, such as pulp, or mineral pigments, such as ground calcium carbonate (GCC), clay and calcium sulfate, or synthetic pigments, such as precipitated calcium carbonate, silica, and polymer pigment, with a dithionite solution. The present invention also relates to bleached lignocellulosic material or pigment obtained with said method. The present invention also relates to a method for preparing a dithionite solution.

### BACKGROUND OF THE INVENTION

Sodium dithionite (sodium hydrosulfite) is an agent generally used in bleaching of many different materials, e.g. paper pulp, cotton, wool and other textiles, clay and other mineral pigments. As a reducing agent, it finds applications in chemical, pharmaceutical and vat dyeing processes. Several methods for preparing sodium dithionite are known in the art. Because the dithionite solution is relatively unstable, it is generally prepared shortly before use. Dry dithionite can be prepared by different methods and it is more stable than the solution, however a significant drawback is that the powder is flammable. Hence, it is practical to prepare the dithionite in situ from stable liquid starting materials to avoid the handling of flammable or dusting powder.

Dithionite can be manufactured by several process routes: the reaction of sodium formate with caustic soda and sulfur dioxide in an aqueous methanol, by reduction of sodium bisulfite with sodium amalgam, electrochemically or with zinc dust.

In the early 1970's a liquid process was commercialized in North America, which is based on sulfur dioxide and caustic soda or bisulfite reduction by borohydride. This method is mainly used in high volume mechanical pulp reductive bleaching. The description of the method for preparing dithionite based on sodium borohydride is disclosed in U.S. Pat. No. 4,788,041, wherein the reaction equation can be presented in the following form:

[NaBH₄+3.2 NaOH]+4.8 NaOH+8 SO₂→4 Na₂S₂O₄+NaBO₂+6 H₂O

Generally [NaBH₄+3.2 NaOH] represents sodium borohydride solution containing about 12% NaBH₄, about 40% NaOH and about 48% water. One example of such generally used commercially available solution is commercially available under the trademark Borino® (Kemira Chemicals Oy).

It is important to carry out the reaction at the proper pH, because at too acidic conditions the yield is decreased because of the hydrolysis of borohydride. On the other hand at too high pH, the yield of the main reaction is decreased. In U.S. Pat. No. 4,788,041 it is mentioned that the optimal pH is 5.5-6. According to said publication, the hydrolysis of the borohydride can be decreased by lowering the reaction temperature to the range of 7-10° C.

In EP Patent No. 1524241, it is disclosed that lye and part of the sulfur dioxide can be introduced as ready sodium bisulfite solution, which has been prepared from sulfur-containing gases as follows:

NaOH+SO₂→NaHSO₃

If sodium bisulfite is used in the preparation of sodium dithionite, the lye of the borohydride solution must be neutralized in order to obtain a pH low enough for the reaction. The pH can be adjusted by using inorganic or organic acids.

Typical drawbacks of the present methods are raw material caustic soda, which is produced by high cost electricity, zinc and amalgam, which are polluting compounds or the process requires organic solvent for example toxic methanol.

There is therefore a great need to further develop economically and environmentally sound methods for preparing dithionite. Further, it is also desired to develop more cost efficient bleaching reagents and methods.

The reductive bleaching process is the dominant process used in bleaching of mechanical pulp and recycled fiber pulps. The amount of dithionite varies around 10 kg/t pulp. As the number of available chromophores for the reductions process is limited, typically a brightness plateau is reached at an input of dithionite between 12 and 15 kg/t pulp. Combined peroxide and dithionite (Y-P or P-Y) bleaching sequences are typically applied in integrated mills producing paper with high brightness grades.

### BRIEF SUMMARY OF THE INVENTION

In the present invention it was surprisingly discovered that magnesium dithionite has several advantages in the treatment of lignocellulosic material or pigment when compared to e.g. generally used sodium dithionite, especially when the treatment also contains at least one peroxide stage.

The present invention provides a method for treating lignocellulosic material or pigment with reductive bleaching solution in at least one reductive stage (Y) wherein the reducing agent is magnesium dithionite and the method contains at least one peroxide stage (P).

The present invention also provides a method for treating lignocellulosic material or pigment with reductive bleaching solution which contains magnesium bisulfite and borohydride in at least one reductive stage (Y) and the method contains at least one peroxide stage (P).

The present invention also provides a method for preparing dithionite solution with a reaction wherein bisulfite is reduced with borohydride solution to obtain dithionite wherein the bisulfite is magnesium bisulfite.

The present invention also provides bleached lignocellulosic material obtained with said treatment methods.

The present invention also provides bleached pigment obtained with said treatment methods.

One advantage of the present invention is that the magnesium ions are beneficial in dithionite-peroxide bleaching sequence. Magnesium stabilizes the reaction in the peroxide phase resulting in higher peroxide residue. Therefore, more peroxide is left in the water circulation, thus improving the brightness. The residual peroxide also ensures control of bacterial growth at pulp storage and the paper machine. Further, the conductivity of the bleaching filtrate (ionic trash) lowers significantly and less processing is needed for example in the form of retention aid addition.

Another advantage of the present invention is that the use of magnesium is cost efficient. When lower quality magnesite (MgCO₃) or magnesia (MgO) can be used in the production of magnesium bisulfite, remarkable savings will be achieved compared to sodium hydroxide.

Still another advantage is that less dithionite is needed to acquire the same final brightness of mechanical pulps, recycled cellulose fiber (RCF) and mineral pigments in association with magnesium instead of sodium.

Strongly acidic magnesium bisulfite can also be used as a pH adjusting agent in the bleaching reaction.

The use of magnesium dithionite is easily adaptable to sulfite pulping plants. Simply cooking liquor could be used as raw material when moderate brightness gain is needed.

Magnesium bisulfite is easily produced from SO₂ gas and caustic magnesium compound, such as an oxide, carbonate or hydroxide, and it can be transported as concentrated clear solution in a safe and cost-effective process. Therefore the use of hazardous SO₂ gas in the bleaching plant and related gas absorption equipment may be avoided.

### BRIEF DESCRIPTION OF THE DRAWINGS

FIG. 1 shows the optimization of bisulfite dosages with Borino dosage of 1 kg/t for bleaching of mixed office waste (MOW).

FIG. 2 shows the optimization of Borino dosages with constant sodium/magnesium bisulfite dosage for bleaching of mixed office waste (MOW).

FIG. 3 shows the conductivity of Borino bleaching filtrates with different magnesium and sodium bisulfite dosages for bleaching of mixed office waste (MOW).

FIG. 4 shows the Borino-peroxide bleaching sequence for bleaching of OMG DIP.

FIG. 5 shows the Borino-peroxide bleaching sequence for bleaching of ONP DIP.

FIG. 6 shows the brightness increase in sodium dithionite and magnesium dithionite bleaching with chemical dosages of 5 and 10 kg/t for bleaching of mixed office waste (MOW).

FIG. 7 shows the a*-value reduction using sodium and magnesium dithionite for bleaching of mixed office waste (MOW).

FIG. 8 shows the brightness increase in dithionite and peroxide sequence bleaching of groundwood (GW). Both sodium and magnesium dithionite were dosed as solutions and their concentration was determined by titration. The peroxide dosage in the peroxide-dithionite (P-Y) sequence was 24 kg/t pulp (P1) and in the Y-P-Y sequence 20 kg/t pulp (P2).

FIG. 9 shows the brightness increase of GW after Borino bleaching applying 2.5 kg/t pulp Borino and varying sodium/magnesium bisulfite dosages.

FIG. 10 shows the conductivity of GW bleaching filtrates after Borino bleaching applying 2.5 kg/t pulp Borino and varying sodium/magnesium bisulfite dosages.

FIG. 11 shows the Borino bleaching tests with magnesium and sodium bisulfite with calcium sulfate.

FIG. 12 shows a comparison of sodium and magnesium bisulfite's ability to neutralize pH.

### DETAILED DESCRIPTION OF THE INVENTION

The present invention provides a method for treating lignocellulosic material or pigment with a reductive bleaching solution in at least one reductive stage (Y). The lignocellulosic material generally refers to lignocellulosic fiber materials, which include fiber made of annual or perennial plants or wooden raw material by, for example, mechanical, chemimechanical or chemical pulping.

In one embodiment of the invention, the lignocellulosic material is pulp. The pulps to be treated include all suitable pulps, especially mechanical pulps or recycled paper pulps, such as deinked pulp (DIP), mixed office waste (MOW), old magazines (OMG) and old newspaper (ONP). Also textiles, sulfite pulp, pulps containing inks and tones and certain chemical pulps may be treated with the method of the invention. The pigments to be treated include mineral or synthetic pigments, such as calcium sulfate (gypsum), clay, earth metal carbonates, such as calcium carbonate and magnesium carbonate (e.g. dolomite), talc, titanium dioxide, mica, bentonite, silica, feldspar and baryte.

The pigment may be applied to the bleaching reaction as slurry, and the bleaching solution may be in any suitable form, such as in an aqueous solution. General methods and conditions for bleaching pigments and minerals are disclosed in WO 2005/095709 and a person skilled in the art can apply them to the methods and materials of the present invention.

The reductive treatment of the present invention significantly lowers the conductivity of the washing liquid therefore decreasing the amount of salts. This helps the further treatment of the liquid. The method of the present invention further contains at least one peroxide stage (P). In one embodiment, the peroxide stage is bleaching. In certain embodiments, the order of the stages is Y-P, P-Y or Y-P-Y. The material to be treated is generally washed between the peroxide (P) and reductive (Y) stages. Also, other sequences may be used. Preferred is a sequence comprising stages Y-P, especially for use with recycled fiber materials.

The reductive bleaching solution of the invention may contain magnesium bisulfite and borohydride. Therefore, the present invention provides a method for treating lignocellulosic material or pigment with reductive bleaching solution containing magnesium bisulfite and borohydride.

In one embodiment, the reducing agent in the bleaching solution is magnesium dithionite, which may be prepared on site or in situ. On site means that the synthesis is carried out separately from the target application of the dithionite solution, and the dithionite obtained will be brought promptly to the target, such as bleaching, after preparation. In situ means “in the reaction mixture”, for example in the treatment (bleaching) process.

In one embodiment, the magnesium dithionite is prepared by reducing magnesium bisulfite with borohydride. Commonly used in such reaction is sodium borohydride solution containing about 12% NaBH₄, about 40% NaOH and about 48% water (e.g. Borino® by Kemira Chemicals Oy). Another example of such commercially available reagents is a concentrate containing about 20% NaBH₄ and about 20% NaOH, which may be used if long transportation is required. Generally, the concentration of sodium borohydride may be in the range of 12-40%, but in practice a solution containing more than 20% is not practical since the solution becomes excessively viscous.

In another embodiment the magnesium bisulfite is prepared by reacting magnesium hydroxide, magnesium oxide or magnesium carbonate and sulfur dioxide. In still another embodiment, the magnesium dithionite is prepared by adding magnesium salt to metal or alkaline metal dithionite. Principally, the production cost of the magnesium bisulfite is lower than sodium bisulfite. Furthermore, the benefit of magnesium ion presence is known in peroxide stabilization.

In one embodiment, the pH of the bleaching reaction is adjusted with magnesium bisulfite. This is especially advantageous when preparing dithionite with a reaction wherein bisulfite is reduced with borohydride solution to obtain dithionite. Such borohydride solution may contain stabilizing NaOH (for example generally used Borino®) resulting in high pH and therefore the solution usually needs neutralization, which can be at least partially carried out by dosing acidic magnesium bisulfite more than reduction reaction requires.

### EXAMPLES

The following examples are given to illustrate but not to limit this invention. The dosages are kilograms per metric ton unless otherwise stated.

### Preparation of Magnesium Dithionite

### Example 1

408 grams (g) of 15% magnesium bisulfite solution (pH 2.8) was placed in a 500 milliliter (ml) beaker equipped with magnetic stirrer. The temperature of the solution was adjusted to 2° C. in an ice water bath. 3.1 g of sodium borohydride granules (99%) were added to the solution during 30 minutes. Final pH was 5.8 and temperature 10° C.

The magnesium dithionite concentration was determined to be 9.2% (theoretical 12.2%) giving a yield of 75%.

### Example 2

408 g of 15% magnesium bisulfite solution (pH 2.8) was placed in a 500 ml beaker equipped with magnetic stirrer. Temperature of the solution was adjusted to 2° C. in an ice water bath. 4.5 g of potassium borohydride (98.8%) was added to the solution during 30 minutes. Final pH was 6.4 and temperature 13° C.

The magnesium dithionite concentration was determined to be 10.0% (theoretical 12.1%) giving a yield of 83%.

### Example 3

408 g of 15% magnesium bisulfite solution (pH 2.8) was placed in a 500 ml beaker equipped with magnetic stirrer. Temperature of the solution was adjusted to 2° C. in an ice water bath. 14.6 g of sodium borohydride concentrate solution (21% SBH, 20% NaOH) was added to the solution during 30 minutes. When temperature started to rise, crushed ice was added to the solution in small portions (80 g in all). The final pH was 4.0 and temperature 7° C.

The magnesium dithionite concentration was determined to be 7.8% (theoretical 9.5%) giving a yield of 82%.

### Example 4

408 g of 15% magnesium bisulfite solution (pH 2.8) was placed in a 500 ml beaker equipped with magnetic stirrer. Temperature of the solution was adjusted to 2° C. in an ice water bath. 11.8% sodium borohydride and 40% caustic soda solution was dropped to the solution using a separatory funnel during 30 minutes (26.4 g). When pH reached 4.5 this value was kept by drop wise adding sulfuric acid. The final pH was 4.2 and temperature 16° C.

The magnesium dithionite concentration was determined to be 8.9% (theoretical 10.2%) giving a yield of 87%.

### Comparison of Combined Magnesium Bisulfite—Borohydride Bleaching and Combined Sodium Bisulfite—Borohydride Bleaching for RCF Pulp

### Example 5

Magnesium bisulfite was tested in Borino bleaching compared to sodium bisulfite. The same final brightness, lower conductivity in bleaching filtrates and advantages in peroxide post-bleaching were observed when magnesium bisulfite was applied. Generally, magnesium bisulfite was more effective at lower dosages than sodium bisulfite.

In general, sodium bisulfite and borohydride (Borino® solution) is used in Borino bleaching technology. In this example, the magnesium bisulfite is tested and compared to sodium bisulfite.

Hand-sorted, carefully selected grades of old German news paper (ONP) and magazines (OMG) were repulped separately in a pilot scale drum pulper at 16% consistency at 50° C. in 20 minutes (min.). Deinking chemicals dosed into the pulper are shown in Table 1.

TABLE 1
Pulping chemical dosages

| Chemical | Dosage (kg/t) |
|---|---|
| NaOH | 10 |
| Sodium silicate | 20 |
| H₂O₂ | 3 |
| Fatty acid | 3 |

After pulping, the ONP and OMG pulps were floated on a lab scale flotation cell at 1% consistency to remove the detached ink. After flotation, the pulp was thickened by using a wire bag and a spin dryer. After flotation, the pH of the pulp was slightly alkaline. The residual ink content of ONP was around 450 parts per million (ppm), and the residual ink value of OMG was around 150 ppm, respectively.

The mixed office waste (MOW) containing a lot of colorful papers was collected from Finnish offices. MOW was re-pulped without chemicals and washed to remove the ash. After washing, the MOW pulp was thickened by using a wire bag and a spin dryer. The pH of the pulp was neutral.

The bleaching experiments were done in plastics bags. Chemical dosages were measured volumetrically. The concentration of sodium bisulfite and magnesium bisulfite was analyzed by titration. The sodium and magnesium bisulfites were diluted into around 5% (active) and Borino into 1% (product). The Borino and bisulfite were pre-mixed (for 10 seconds (s)) before adding to the pulp. After that, the temperature controlled pulp and chemical-mixture were mixed by hand in a plastic bag. The initial pH was measured on the pulp before adding chemicals. The pulp bag was kept in a hot water bath (fixed temperature) during the desired reaction time. The final pH was measured from the pulp after sampling.

With MOW, Borino and bisulfite dosages were optimized. With ONP and OMG pulp, the optimum Borino dosages were used. After Borino bleaching and washing stage, peroxide bleaching was carried out with chemical dosages of 10 kiograms per tonne (kg/t) of peroxide, 5 kg/t of NaOH and 6 kg/t of sodium silicate. The peroxide bleaching experiment was done at 10% consistency at 90° C. with 60 min reaction time.

The optimization of Borino bleaching chemicals was done with mixed office waste. The brightness curves of sodium bisulfite and magnesium bisulfite were compared with constant Borino dosage (FIG. 1).

Magnesium bisulfite worked with significantly lower dosage (product based) than sodium bisulfite. 5 kg/t dosage of magnesium bisulfite resulted in brightness of 83 ISO%. The same brightness was achieved with the sodium bisulfite dosage of 7-8 kg/t. The bisulfite content of magnesium bisulfite (Mg(HSO₃)₂) was higher than sodium bisulfite (NaHSO₃), when the dosages are calculated mass based. Generally, if 5 kg/t magnesium bisulfite contains 3.78 kg/t of bisulfite, 5 kg/t of sodium bisulfite contains 3.03 kg/t of bisulfite, respectively. This means that if equal bisulfite dosages are wanted, the results of 6.24 kg/t of sodium bisulfite should be compared to the results achieved with 5 kg/t of magnesium bisulfite. Concerning this aspect, magnesium bisulfite is still slightly more effective than sodium bisulfite.

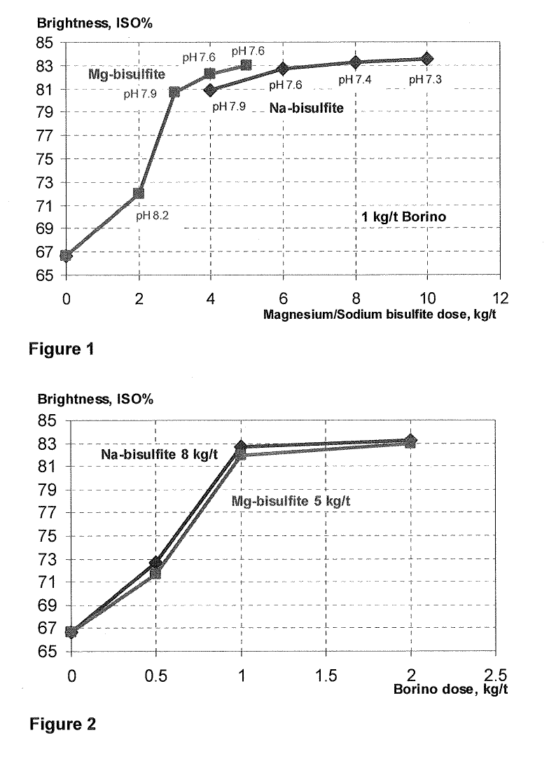

In FIG. 2, the brightness results of Borino optimization are shown. In this case, the bisulfite dosage was kept constant and Borino dosage was changed. With magnesium bisulfite, dosage of 5 kg/t was used and dosage of 8 kg/t with sodium bisulfite.

When magnesium bisulfite or sodium bisulfite was used in Borino bleaching, high bleaching responses were seen already with Borino dosage of 1 kg/t. There was no difference between magnesium bisulfite and sodium bisulfite. Furthermore, significantly lower bisulfite dosages of magnesium bisulfite did not affect the bleaching response.

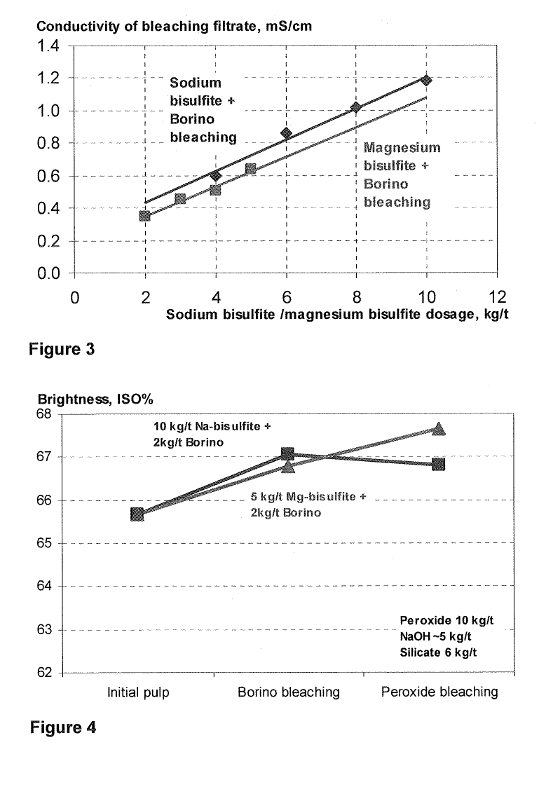

Conductivity was measured from the bleaching filtrates with the different bisulfite dosages (FIG. 3).

Even if the bisulfite content of magnesium bisulfite product was higher, conductivity of the bleaching filtrate was 0.1 millisiemens per centimeter (mS/cm) lower with constant magnesium bisulfite and sodium bisulfite product dosage. The same brightness was obtained with 5 kg/t magnesium bisulfite dosage as 8 kg/t of sodium bisulfite dosage, which means that conductivity was 0.3 mS/cm lower.

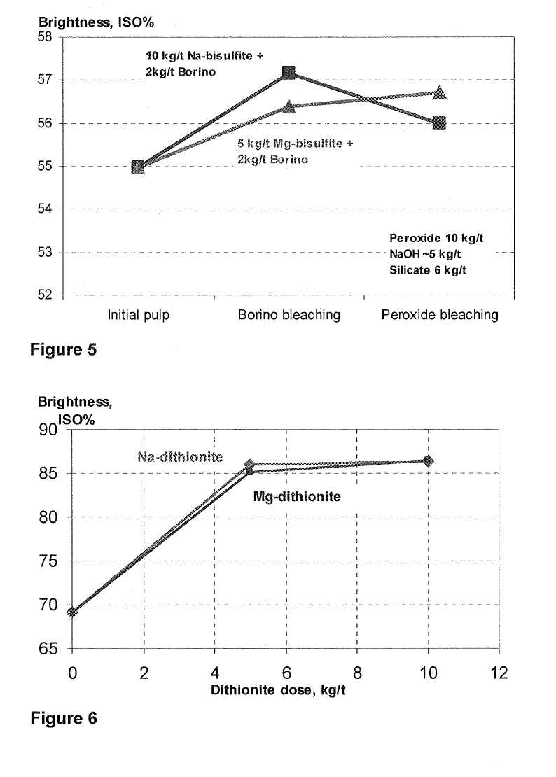

Magnesium bisulfite was also tested in Borino bleaching with ONP and OMG containing DIP (FIGS. 4 and 5). After Borino bleaching, the pulp was washed and the peroxide bleaching was carried out.

As already seen with mixed office waste, sodium bisulfite was slightly more effective than magnesium bisulfite when 10 kg/t of bisulfite and 2 kg/t of Borino were used. Peroxide bleaching after Borino stage was more effective when magnesium bisulfite was applied. Also, the residual peroxide concentration after bleaching was higher (Table 2). The same conclusions can be made with ONP furnish (FIG. 5.).

TABLE 2
The chemical conditions and chemical dosages of peroxide bleaching

| | | peroxide bleaching | | | | | | |
|---|---|---|---|---|---|---|---|---|
| | previous | | | | | | Residual | |
| | bleaching | | | H₂O₂ | measured pH | | H₂O₂ | Base |
| furnish | stage | NaOH kg/t | Silicate kg/t | kg/t | start | end | kg/t | kg/t |
| ONP | Na-bisulfite + | 5.0 | 6 | 10 | 10.5 | 8.3 | 1.48 | 0.29 |
| | borino | | | | | | | |
| | Mg-bisulfite + | 6.4 | 6 | 10 | 10.5 | 8.6 | 2.57 | 0.65 |
| | borino | | | | | | | |
| OMG | Na-bisulfite + | 4.5 | 6 | 10 | 10.4 | 8.2 | 1.31 | 0.79 |
| | borino | | | | | | | |
| | Mg-bisulfite + | 5.6 | 6 | 10 | 10.5 | 8.7 | 2.63 | 1.08 |
| | borino | | | | | | | |

The stabilization effect of magnesium is shown in residual peroxide titrations. The residual peroxide concentration was two times higher when Borino bleaching was carried out with magnesium bisulfite.

Magnesium bisulfite worked with lower dosages than sodium bisulfite in Borino bleaching of MOW, OMG DIP, and ONP DIP; 5 kg/t of magnesium bisulfite (bisulfite content 3.78 kg/t) gave same brightness as 8 kg/t of sodium bisulfite (bisulfite content of 4.86 kg/t). The conductivity of the bleaching filtrate was significantly lower with magnesium bisulfite than sodium bisulfite. Furthermore, peroxide bleaching after Borino bleaching was more effective resulting in higher brightness and residual peroxide concentration.

### Comparison of Magnesium Dithionite and Sodium Dithionite in RCF Bleaching

### Example 6

In this example, magnesium dithionite bleaching was compared to sodium dithionite bleaching with mixed office waste based recycled fiber.

The mixed office waste (MOW) containing lots of colorful papers (red, yellow and green) was collected from Finnish offices. Papers were re-pulped without chemicals in a Kitchen Aid mixer and wet disintegrated at 1.5% consistency. After that, the pulp was washed to remove the ash. After washing, the pulp was thickened by using a wire bag and a spin dryer. The pH of the pulp was neutral.

4% sodium dithionite solution was produced by dissolving the sodium dithionite powder into water.

The magnesium based dithionite solution was prepared according to the procedure described in example 4.

Determination of sodium and magnesium dithionite concentration in the solutions was made by iodine titration after addition of formaldehyde and acetic acid.

The bleaching experiments were made in plastics bags. All the chemical dosages were measured volumetrically. Before bleaching, the consistency of the pulp was adjusted to 5% with hot water. The pH of the hot pulp was adjusted to 7.4 with sulfur acid, which results bleaching pH of 7 after dithionite dosing.

After that, the temperature controlled pulp and desired dithionite solution dosage were mixed by hand in a plastic bag. The pulp bag was kept in a hot water bath (60° C.) for 40 min. The final pH was measured from the pulp after sampling.

With sodium and magnesium based dithionite, dosages of 5 kg/t and 10 kg/t were tested.

The brightness increase in magnesium and sodium dithionite bleaching is shown in FIG. 6.

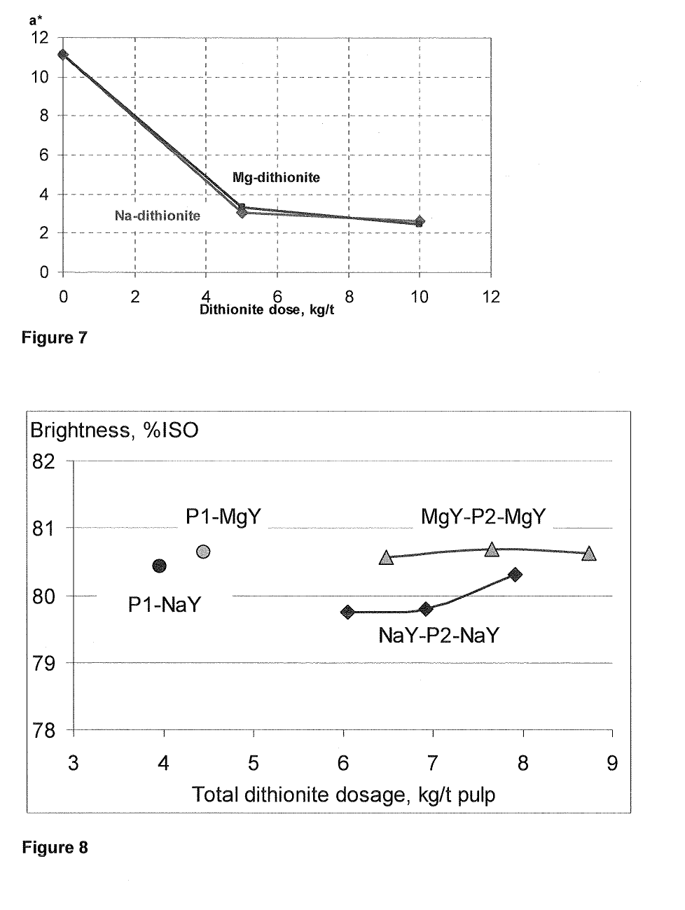

The bleaching response of sodium dithionite and magnesium dithionite was found equal with tested chemical dosages. The bleaching ability of both chemical was similar. Furthermore, no difference was detected in red color stripping (FIG. 7).

Positive a*-value indicates red shade of pulp. The values near to zero are desired.

In mixed office waste based recycled fiber bleaching and color stripping tests, magnesium dithionite performed at least as well as sodium dithionite.

### Comparison of Magnesium Dithionite and Sodium Dithionite in Mechanical Pulp Bleaching

The bleaching response of magnesium based dithionite was compared to the traditional sodium dithionite powder in a single reductive bleaching stage and in bleaching sequences including a peroxide stage (Y-P, P-Y, Y-P-Y). Three different mechanical pulps were used in the following examples TMP 1, TMP 2 and GW (Groundwood) (Table 3). The TMP 1 was not chelated while the other two pulps were chelated with DTPA (3 kg/t pulp, 5% consistency, 60° C., 15 min) before bleaching.

TABLE 3
Unbleached pulps used in bleaching trials

| | | TMP 1 | TMP 2 | GW |
|---|---|---|---|---|
| Optical | Brightness, % ISO | 51.1 | 57.6 | 67.9 |
| properties | Yellowness | 34.3 | 31.3 | 21.7 |
| | CIE-Whiteness + UV | −18.4 | −4.7 | 24.6 |
| | L | 86.0 | 89.2 | 92.1 |
| | a | 2.07 | 1.62 | −0.02 |
| | b | 17.6 | 16.6 | 12.1 |
| XRF metals | | unchelated | chelated | chelated |
| (mg/kg) | Fe | <10 | <10 | 19 |
| | Mn | 154 | 9 | 3 |
| | Ca | 947 | 692 | 679 |
| | Cu | <1 | <1 | 4 |

### Example 8

TMP 1 was bleached at 10% concentration in plastic bags for 30 min at 90° C. (Table 4). The magnesium based dithionite solutions were prepared according to the procedure described in example 4. The dithionite concentration in the solutions was determined by titration. The reference bleaching was made using sodium dithionite in powder form. The powder was dosed as product.

TABLE 4
Bleaching results for TMP 1

| | Na-dithionite | | | | Mg-dithionite | | | |
|---|---|---|---|---|---|---|---|---|
| Dithionite | 10 | 12 | 15 | 20 | 8.9 | 10.7 | 13.4 | 17.9 |
| dosage, kg/tp | | | | | | | | |
| Final-pH | 5.1 | 4.7 | 5.0 | 4.7 | 5.0 | 4.8 | 4.9 | 4.9 |
| Brightness, | 58.4 | 58.6 | 58.5 | 58.4 | 58.6 | 58.9 | 59.2 | 59.1 |
| % ISO | | | | | | | | |
| Whiteness | −0.95 | 0.46 | −0.81 | −1.52 | 0.18 | 0.79 | 1.63 | 1.76 |
| CIE D65/10 + | | | | | | | | |
| UV | | | | | | | | |
| Yellowness | 28.2 | 27.9 | 28.2 | 28.5 | 27.7 | 27.6 | 27.3 | 27.2 |
| L* | 88.9 | 89.0 | 89.0 | 89.1 | 88.9 | 89.1 | 89.2 | 89.1 |
| a* | 0.05 | 0.15 | −0.01 | 0.05 | −0.06 | −0.12 | −0.19 | −0.11 |
| b* | 15.6 | 15.4 | 15.7 | 15.8 | 15.4 | 15.3 | 15.2 | 15.1 |

The total brightness gain was approximately 8% ISO. The brightness plateau was 0.7% ISO higher when bleaching with magnesium dithionite compared to bleaching with sodium dithionite (Table 4).

### Example 9

TMP 2 was bleached at 10% consistency in plastic bags for 45 min at 70° C. (Table 5). The magnesium based dithionite solutions were prepared according to the procedure described in example 4. The sodium dithionite powder was dissolved in water before addition to the pulp suspension. The sodium and magnesium dithionite concentration in the solutions were determined by titration.

TABLE 5
Bleaching results for TMP 2

| | Na-dithionite | | | | Mg-dithionite | | | |
|---|---|---|---|---|---|---|---|---|
| Dithionite | 2.6 | 5.1 | 7.8 | 10.3 | 3.6 | 7.1 | 10.7 | 14.2 |
| dosage, kg/tp | | | | | | | | |
| Final-pH | 4.5 | 4.3 | 4.3 | 4.5 | 4.6 | 4.5 | 4.3 | 3.9 |
| Brightness, | 63.1 | 64.9 | 64.8 | 66.1 | 64.6 | 65.7 | 66.1 | 65.8 |
| % ISO | | | | | | | | |
| Whiteness | 6.8 | 10.6 | 11.2 | 15.0 | 10.6 | 12.7 | 13.4 | 12.3 |
| CIE D65/10 + | | | | | | | | |
| UV | | | | | | | | |
| Yellowness | 27.3 | 26.2 | 25.8 | 24.5 | 26.3 | 25.2 | 25.1 | 25.5 |
| L* | 91.4 | 92.1 | 91.8 | 92.2 | 91.9 | 92.2 | 92.4 | 92.4 |
| a* | 0.03 | −0.35 | −0.36 | −0.56 | −0.32 | −0.67 | −0.76 | −0.69 |
| b* | 15.5 | 15.1 | 14.8 | 14.2 | 15.1 | 14.7 | 14.7 | 14.9 |

The total brightness gain was approximately 8.5% ISO. The pH after the bleaching (Final pH) dropped quite significantly for the Mg based dithionite at higher dosages. This could have had a negative effect on the bleaching results. However, the bleaching response for the magnesium based dithionite seemed to be on the same level or slightly higher than the sodium based dithionite (Table 5). The brightness plateau was on the same level and the bleaching response per dosed amount of dithionite was also in the same magnitude.

### Example 10

GW was bleached with a Y-P-Y sequence where the dithionite stages were carried out in plastic bags. The initial Y stage was at 8% consistency (Table 6) and the final Y stage was at 9.5% consistency. The reaction temperature in both stages was 60° C. for 15 min. The magnesium based dithionite solutions were prepared according to the procedure described in example 4. The sodium dithionite powder was dissolved in water before addition to the pulp suspension. The sodium and magnesium dithionite concentration in the solutions were determined by titration. The intermediate peroxide stage was mixed at high consistency (28%) in a quantum mixer before keeping the pulp in a water bath for 3 h at 65° C.

TABLE 6
Bleaching results of the initial Y stage for GW

| | Na-dithionite | | | | | | Mg-dithionite | | | | | |
|---|---|---|---|---|---|---|---|---|---|---|---|---|
| Dithionite dosage, kg/tp | 1.0 | 2.0 | 2.0 | 3.1 | 3.9 | 5.1 | 0.5 | 1.1 | 2.1 | 2.2 | 3.2 | 4.3 |
| Final-pH | 5.1 | 4.8 | 5 | 5 | 5.1 | 4.9 | 5.1 | 4.8 | 4.8 | 4.7 | 4.8 | 4.7 |
| Brightness, % ISO | 69.0 | 69.9 | 70.0 | 71.6 | 71.7 | 71.8 | 68.1 | 69.5 | 71.4 | 71.8 | 71.6 | 71.5 |
| Whiteness CIE D65/10 + UV | 24.9 | 26.8 | 26.6 | 30.7 | 31.2 | 30.9 | 23.5 | 25.7 | 30.0 | 30.7 | 30.1 | 29.9 |
| Yellowness | 22.0 | 21.1 | 21.4 | 19.9 | 19.8 | 20.0 | 22.3 | 21.8 | 20.3 | 20.0 | 20.1 | 20.2 |
| L* | 92.9 | 93.1 | 93.3 | 93.6 | 93.6 | 93.7 | 92.4 | 93.1 | 93.6 | 93.7 | 93.5 | 93.5 |
| a* | −0.25 | −0.62 | −0.51 | −0.77 | −0.79 | −0.73 | −0.08 | −0.35 | −0.74 | −0.83 | −0.8 | −0.81 |
| b* | 12.5 | 12.2 | 12.3 | 11.7 | 11.6 | 11.7 | 12.5 | 12.4 | 11.8 | 11.7 | 11.7 | 11.8 |

At lower dosages (2 kg/t pulp), the bleaching response for the magnesium based dithionite was seen to be higher by up to 1.4% ISO than for the sodium based dithionite. The final brightness plateau was on the same level (Table 6).

The brightness after the peroxide stage (Y-P) was not much affected by the dithionite dosage in the initial bleaching stage. The reference peroxide bleaching (P1, 24 kg/t pulp H₂O₂, 17 kg/t pulp NaOH, and 6 kg/t pulp silicate) resulted in 0.5% ISO higher brightness compared to the Y-P (P2, 20 kg/t pulp H₂O₂, 15 kg/t pulp NaOH, and 6 kg/t pulp silicate) (Table 7).

Magnesium dithionite in the final Y stage was clearly more effective than with sodium dithionite. This was seen as higher brightness after the full bleaching sequence (Y-P-Y) for the pulps bleached with magnesium dithionite. The same brightness was obtained with the magnesium based Y-P-Y sequence as with the P-Y even if the peroxide dosage in the Y-P-Y was 17% (4 kg/t pulp H₂O₂) lower than in the P-Y. In other words, 2 kg of magnesium dithionite in an initial Y stage could replace 4 kg of peroxide in the P stage (FIG. 8).

TABLE 7
Bleaching results for GW using P-Y, Y-P and Y-P-Y sequences

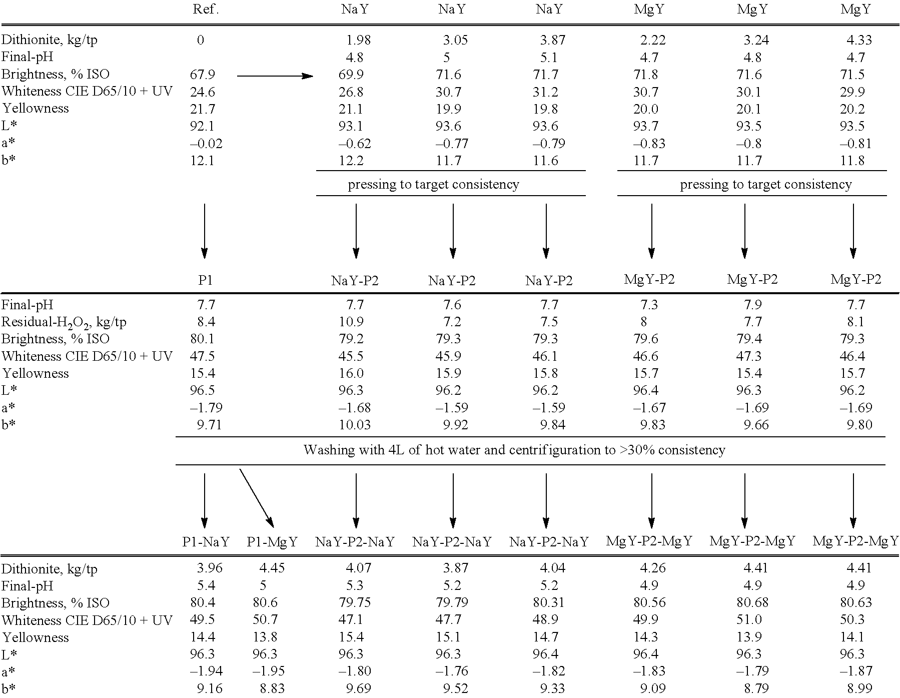

### Example 10

GW was Borino bleached at 10% concentration. The bleaching was carried out in plastic bags for 30 min at 90° C. The sodium and magnesium bisulfites were diluted into 4% (as titrated active compound) and Borino into 1% (as product). The Borino and bisulfite were pre-mixed (for 10 s) before adding to the pulp. The Borino dosage was 2.5 kg/t pulp and the sodium and magnesium bisulfite dosages were 10, 12 and 14 kg/t pulp (as product).

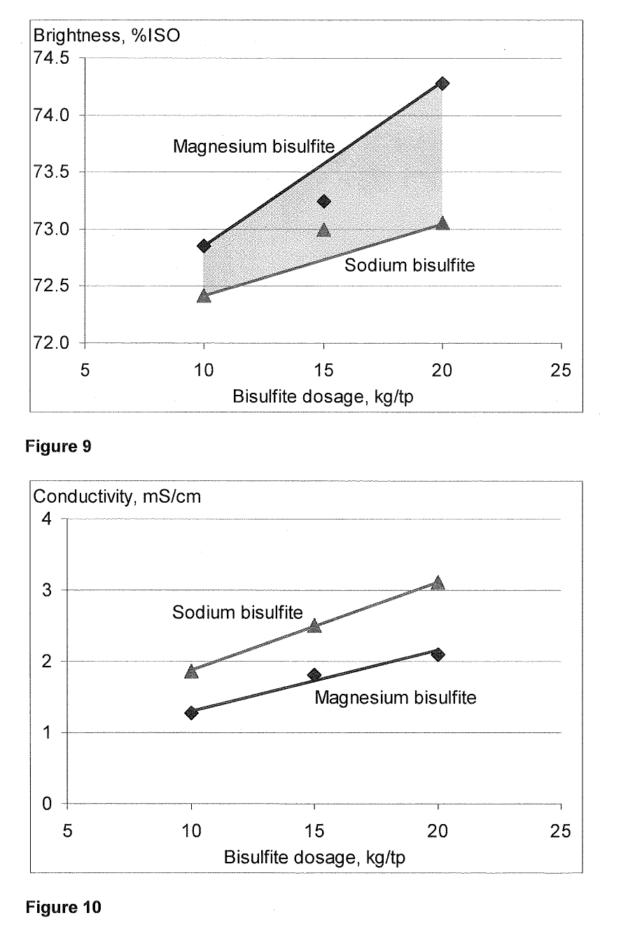

The brightness after Borino bleaching was found to be 0.5-1% ISO higher after bleaching with magnesium bisulfite compared to sodium bisulfite (FIG. 9). Another significant benefit of the magnesium bisulfite is the 30% lower conductivity of the bleaching filtrate (FIG. 10). The decrease in conductivity is over 50% if compared at approximately the same final brightness.

### Comparison of Combined Magnesium Bisulfite—Borohydride Bleaching and Combined Sodium Bisulfite—Borohydride Bleaching for Calcium Sulfate (Mineral Pigment)

### Example 11

Raw calcium sulfate from a Finnish north-eastern mine was used in Borino bleaching study. The bleaching studies were performed at 20% solids and at 50° C. temperature for 40 min. The water-calcium sulfate-mixture was kept in temperature controlled magnetic stirrer (750 rpm) during bleaching.

The concentration of sodium bisulfite and magnesium bisulfite was analyzed by titration before bleaching. The sodium and magnesium bisulfites were diluted into around 5% (active) and Borino into 1% (product). The Borino and bisulfite were pre-mixed (for 10 s) before adding to the calcium sulfate suspension.

The pH was measured from the calcium sulfate suspension before and after bleaching.

The initial calcium sulfate sample and the samples after bleaching were filtered with Buchner funnel (filter paper 640d). After that, the solids were dried in a heating oven at +40° C. over night. Dry calcium sulfate was ground with Janke & Kunkel grinder for 3 min. From the powder, a tablet was compressed for brightness measurement. The brightness was measured with Minolta brightness meter.

The Borino dosage was kept constant (2 kg/t) and sodium bisulfite and magnesium bisulfite was changed in calcium sulfate bleaching tests. The initial pH of the water+calcium sulfate-mixture was 7.9 and pH's after bleaching are presented in Table 8.

TABLE 8
pH values in Borino bleaching.

| Borino, | | | |
|---|---|---|---|
| kg/t | Bisulfite dosage, kg/t | | pH |
| 2 | | 5 | 7.73 |
| 2 | Na-bisulfite | 7.5 | 7.61 |
| 2 | | 10 | 7.49 |
| 2 | | 2.5 | 7.90 |
| 2 | Mg-bisulfite | 3.75 | 7.69 |
| 2 | | 5 | 7.57 |

After bleaching, the pH-values were around 7.5. The higher the bisulfite dosage was the lower was the pH. The brightness results of calcium sulfate are presented in FIG. 11.

Magnesium bisulfite gave significantly higher brightness with much lower chemical dosages than sodium bisulfite in Borino bleaching. The brightness increase in Mg-bisulfite+Borino application was around 2% ISO. With sodium bisulfite+Borino, the brightness gain was 1 to 1.5% ISO.

In calcium sulfate bleaching, magnesium bisulfite+borohydride bleaching was much more effective than sodium bisulfite+borohydride bleaching.

### Comparison of Magnesium Bisulfite and Sodium Bisulfite in pH Adjustment

### Example 12

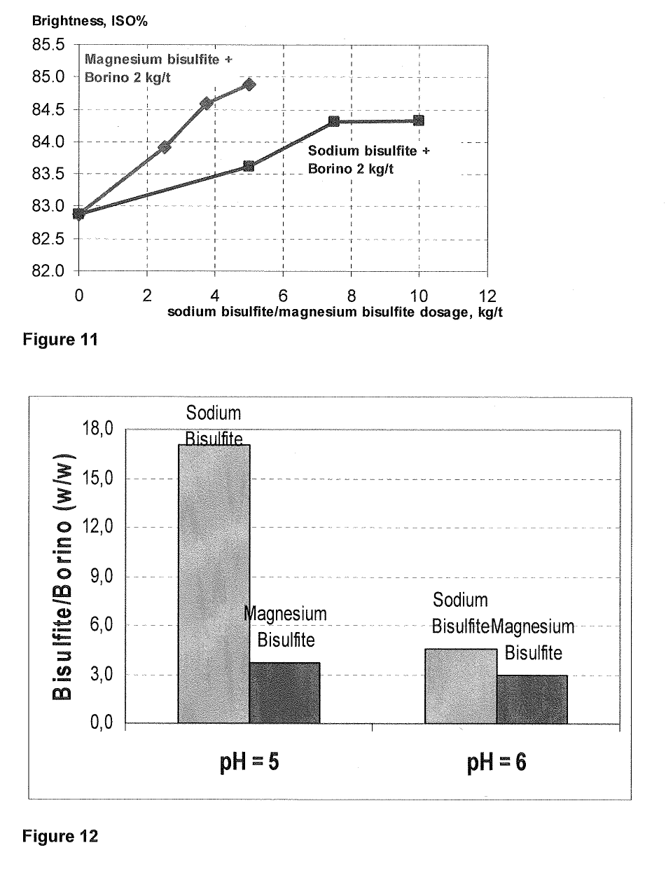

In this example, bisulfite ability to neutralize pH was tested. 100 ml of cooled water was stirred in a beaker and Borino and bisulfite were added into the solution drop by drop so that the determined pH was constant. Borino dosage was 10 grams and the dosages of both bisulfites were monitored. The results are presented in FIG. 12 and in Table 9.

In example 12 analyzed dithionite levels were between 6-7% except for sodium bisulfite at pH 5, where dithionite dropped to 2.2%. It is obvious that less magnesium bisulfite of these bisulfites is needed to achieve desired pH level in order to get high yield of dithionite.

TABLE 9
Required bisulfite dosage in proportion
to Borino to reach certain pH value.

| | pH = 5 | pH = 6 |
|---|---|---|
| Sodium Bisulfite | 17.1 | 4.6 |
| Magnesium | 3.8 | 3.0 |
| Bisulfite | | |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for treating lignocellulosic material or pigment with reductive bleaching solution in at least one reductive stage (Y), comprising:
washing the lignocellulosic material or pigment in the at least one reductive stage (Y) with a reductive bleaching solution comprising magnesium dithionite; and
washing the lignocellulosic material or pigment in at least one peroxide stage (P) with a peroxide.

2. The method of claim 1, wherein the magnesium dithionite is prepared by reducing magnesium bisulfite with borohydride.

3. The method of claim 2, wherein the magnesium bisulfite is prepared by reacting magnesium hydroxide, magnesium oxide or magnesium carbonate and sulfur dioxide.

4. The method of claim 1, wherein the magnesium dithionite is prepared by adding magnesium salt to metal or alkaline metal dithionite.

5. The method of claim 1, wherein the dithionite solution is prepared on site or in situ.

6. The method of claim 1, wherein a pH of the reductive bleaching solution is adjusted with the magnesium bisulfite.

7. A method for treating lignocellulosic material or pigment with a reductive bleaching solution in at least one reductive stage (Y), comprising:
washing the lignocellulosic material or pigment in the at least one reductive stage (Y) with a reductive bleaching solution comprising magnesium bisulfite and borohydride; and
washing lignocellulosic material or pigment with the method contains at least one peroxide stage (P) with a peroxide

8. The method of claim 7, wherein washing in the at least one peroxide stage is bleaching.

9. The method of claim 7, wherein an order of the at least one reductive and the at least one peroxide stages is Y-P, P-Y or Y-P-Y.

10. The method of claim 7, wherein the lignocellulosic material is a pulp.

11. The method of claim 7, wherein the pigment is a mineral pigment or a synthetic pigment.

12. The method of claim 11, wherein the mineral pigment is calcium sulfate, clay, earth metal carbonates, talc, titanium dioxide, mica, bentonite, silica, feldspar or baryte.

13. Bleached lignocellulosic material obtained with the method of claim 1.

14. Bleached pigment obtained with the method of claim 1.

15. Bleached lignocellulosic material obtained with the method of claim 7.

16. Bleached pigment obtained with the method of claim 7.

17. The method of claim 7, wherein an order of the at least one reductive and the at least one peroxide stages is Y-P, P-Y or Y-P-Y.
